(19) United States
(12) Patent Application Publication
(10) Pub. No.: US 2026/0133515 A1
(43) Pub. Date: May 14, 2026

(54) MAGNETIC ONE-COMPONENT TONER AND IMAGE FORMING APPARATUS USING THE SAME

(71) Applicant: KYOCERA Document Solutions Inc., Osaka (JP)

(72) Inventor: Takeshi ARAKAWA, Osaka (JP)

(73) Assignee: KYOCERA Document Solutions Inc., Osaka (JP)

(21) Appl. No.: 19/382,410

(22) Filed: Nov. 7, 2025

(30) Foreign Application Priority Data
Nov. 14, 2024 (JP) 2024-199261

(51) Int. Cl. G03G 9/087; G03G 9/083; G03G 9/093; G03G 15/09

(52) U.S. Cl. CPC G03G 9/08755; G03G 9/0833; G03G 9/0835; G03G 9/0838; G03G 9/09342; G03G 15/0914; G03G 2215/0619

(57) ABSTRACT

Magnetic one-component toner includes a toner base particle containing at least a binder resin and a magnetic powder and an external additive attached to its surface. The binder resin contains an amorphous polyester resin and a crystalline polyester resin containing an aliphatic diol with a carbon number of 3 or more but 9 or less. The amount of crystalline polyester resin added is 5 mass % or less relative to the amorphous polyester resin. Let Tg1 be the glass transition point measured using a differential scanning calorimeter when temperature is first raised and let Tg2 be the glass transition point measured when, after the Tg1 measurement, temperature is lowered and raised again, then Tg(45) and Tg(25), which are the values of Tg1 measured after standing still at 45° C. and 25° C., respectively, for 100 hours, satisfy 0<Tg2−Tg(45)<5 and 4<Tg2−Tg(25)<10.

### INCORPORATION BY REFERENCE

This application is based on and claims the benefit of priority from Japanese Patent Application No. 2024-199261 filed on Nov. 14, 2024, the contents of which are hereby incorporated by reference.

### BACKGROUND

The present disclosure relates to magnetic one-component toner and an image forming apparatus of a magnetic one-component development type using magnetic one-component toner.

In general, in electrophotography, the surface of an electrostatic latent image carrying member is electrostatically charged by corona discharge or the like and is then exposed to laser light or the like to form an electrostatic latent image. The formed electrostatic latent image is developed with toner to form a toner image. The formed toner image is then transferred to a recording medium to obtain a high-quality image.

Known methods for developing the electrostatic latent image with toner include: magnetic one-component development method, which uses only magnetic toner; and two-component development method, which uses two-component developer containing non-magnetic toner and magnetic carrier. Since magnetic toner is inexpensive compared with two-component developer, magnetic one-component development method is commonly used in monochrome printers.

For the magnetic one-component development method, to cope with faster image forming apparatuses and a wider variety of printing media, demand is high for further improvement in toner's low temperature fixing properties and many studies have been made for that purpose. For example, known technologies include blending an amorphous polyester resin with a crystalline polyester as a plasticizing agent to improve low temperature fixing properties. Inconveniently, compatibilizing a crystalline polyester with an amorphous polyester has a great effect of lowering the glass transition point (Tg), and this may degrade toner's preservation properties.

### SUMMARY

According to one aspect of the present disclosure, magnetic one-component toner includes a toner particle having a toner base particle containing at least a binder resin and a magnetic powder and having an external additive attached to the surface of the toner base particle. The binder resin contains an amorphous polyester resin and a crystalline polyester resin, and the amount of crystalline polyester resin added is 5 mass % or less relative to the amorphous polyester resin. The crystalline polyester resin includes one or more aliphatic diols with a carbon number of 3 or more but 9 or less. Let Tg1 be the glass transition point measured using a differential scanning calorimeter when temperature is raised for the first time and let Tg2 be the glass transition point measured when, after the measurement of Tg1, temperature is lowered and raised again, then Tg(45), which is the value of Tg1 measured after standing still at 45° C. for 100 hours and Tg(25), which is the value of Tg1 measured after standing still at 25° C. for 100 hours satisfy formulae (1) and (2) below:

$$0 < T g 2 - T g ( 45 ) < 5 \qquad ( 1 )$$

$$4 < Tg 2 - T g ( 25 ) < 10 \qquad ( 2 )$$

### BRIEF DESCRIPTION OF THE DRAWINGS

FIG. 1 is a schematic sectional view of an image forming apparatus that uses magnetic one-component toner according to the present disclosure.

### DETAILED DESCRIPTION

### [1. Overall Configuration of Image Forming Apparatus]

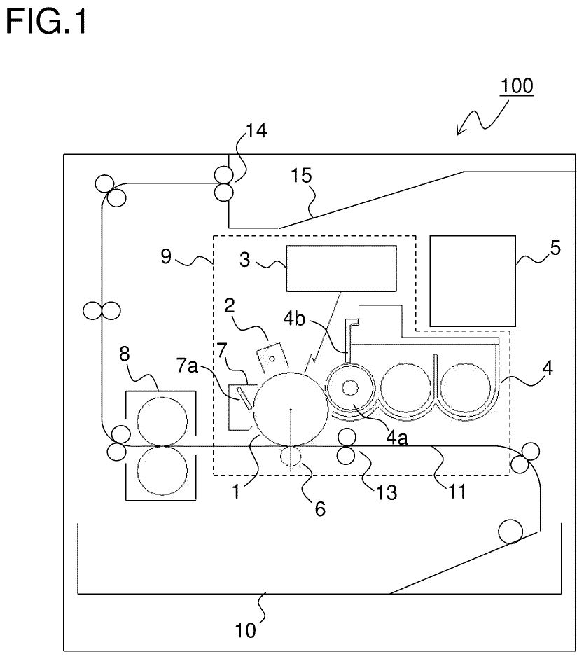

Hereinafter, an embodiment of the present disclosure will be described with reference to the accompanying drawing. FIG. 1 is a schematic sectional view of an image forming apparatus 100 in which magnetic one-component toner according to the present disclosure is used. In the image forming apparatus (e.g., a monochrome printer) 100, when a printing operation is performed, in an image forming portion 9 inside the image forming apparatus 100, an electrostatic latent image is formed based on original-image data received from a host device (not shown) such as a personal computer or the like, and a developing device 4 attaches toner to the electrostatic latent image to form a toner image. Toner is supplied to the developing device 4 from a toner container 5. In the image forming apparatus 100, while rotating a photosensitive drum 1 in a clockwise direction in FIG. 1, the image forming process is executed with respect to the photosensitive drum 1.

The image forming portion 9 includes, arranged along the rotation direction of the photosensitive drum 1 (the clockwise direction), a charging device 2, an exposure unit 3, the developing device 4, a transfer roller 6, a cleaning device 7, and a charge eliminating device (not shown). The photosensitive drum 1 is formed by laying a photosensitive layer on the surface (outer circumferential surface) of an aluminum drum, for example. The surface (outer circumferential surface) of the photosensitive drum 1 is uniformly charged by the charging device 2. Then, on the surface irradiated with a light beam from the exposure unit 3, which will be described later, an electrostatic latent image is formed through attenuation of electric charge. Although the photosensitive layer is not particularly limited in material, it is preferably formed of amorphous silicon (a-Si), for example, for its excellent durability. The linear velocity of the photosensitive drum 1 (i.e., the process linear velocity of the image forming apparatus 100) is 250 mm/sec or more.

The charging device 2 uniformly charges the surface of the photosensitive drum 1. Used as the charging device 2 is, for example, a corona discharge device that produces electric discharge by applying a high voltage to an electrode such as a piece of fine wire. Instead of a corona discharge device, there may be employed a contact-type charging device that achieves voltage application while a charging member, as exemplified by a charging roller, is in contact with the surface of the photosensitive drum 1. The exposure unit 3 irradiates the photosensitive drum 1 with a light beam (for example, a laser beam) according to image data and thereby forms an electrostatic latent image on the surface of the photosensitive drum 1.

The developing device 4 attaches toner to the electrostatic latent image on the photosensitive drum 1 to form a toner image. In the embodiment, magnetic one-component toner (magnetic one-component developer) is stored in the developing device 4. The developing device 4 employs a magnetic one-component jumping development method and includes a mechanism that has a non-contact regulation blade 4b for a development roller 4a and that electrostatically charges toner via the development roller 4a. The cleaning device 7 includes a cleaning blade 7a in line contact with the photosensitive drum 1 in its longitudinal direction (i.e., direction perpendicular to the plane of FIG. 1), and the cleaning blade 7a removes residual toner remaining on the surface of the photosensitive drum 1 after the toner image has been moved (transferred) onto a sheet.

Toward the photosensitive drum 1, on which the toner image has been formed in the above-described manner, a sheet is conveyed at a predetermined timing from a sheet storage portion 10 via a sheet conveyance path 11 and a registration roller pair 13 to the image forming portion 9. The transfer roller 6 is in contact with the photosensitive drum 1, thereby forming a nip portion (a transfer nip portion), and moves (transfers) the toner image having been formed on the surface of the photosensitive drum 1 onto the sheet passing through the transfer nip portion without image distortion. After that, in preparation for subsequent formation of a new electrostatic latent image, residual toner left on the surface of the photosensitive drum 1 are removed by the cleaning device 7, and residual charge is eliminated by the charge eliminating device.

The sheet, onto which the toner image has been transferred, is separated from the photosensitive drum 1 to be conveyed to the fixing device 8, where heat and pressure are applied to the sheet to fix the toner image onto the sheet. The sheet having passed through the fixing device 8 is ejected via an ejection roller pair 14 to a sheet ejection portion 15.

### [2. Basic Configuration of Toner]

A description will be given below of the magnetic one-component toner according to the present disclosure (hereinafter also referred to simply as the toner) used in the image forming apparatus 100. Unless otherwise defined, a result of evaluation (i.e., a value related to a shape, property, or the like) with respect to a powdery substance (specifically, toner core particle, toner base particle, external additive, toner, and the like) is given as a number average of values obtained by measuring respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (“LA-750” manufactured by HORIBA, Ltd.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Whenever the name of a compound has “-based” appended to it to refer to the name of a polymer, the repeating unit in the polymer is derived from any of that compound and their derivatives. The term “(meth)acrylic” is occasionally used to refer to “acrylic” and “methacrylic” collectively. The term “(meth)acryloyl” is occasionally used to refer to “acryloyl” (CH₂═CH—CO—) and “methacryloyl” (CH₂—C(CH₃)—CO—) collectively.

Toner according to the embodiment can be used as positively chargeable toner suitably for development of electrostatic latent images. The toner according to the embodiment is a powdery substance containing a plurality of toner particles (each a particle configured as described later). The toner contains a magnetic powder and is used as one-component developer.

The toner particles of the toner according to the embodiment have a toner base particle and an external additive attached to the surface of the toner base particle. The toner base particle contains at least a binder resin and a magnetic powder. As necessary, the toner base particle can contain, in the binder resin, a release agent, a charge control agent, and the like. The toner base particle contains, as a binder resin, an amorphous polyester resin and a crystalline polyester resin.

Adding too large an amount of crystalline polyester resin can result in compatibilization of the amorphous polyester resin with the crystalline polyester resin and thus a lower glass transition point (Tg). This causes problems such as degraded heat-resistant preservation properties of toner. To avoid that, in the toner according to the present disclosure, the amount of crystalline polyester resin added is 5 mass % or less relative to the amorphous polyester resin.

Let Tg1 be the glass transition point of the toner according to the present disclosure as measured using a differential scanning calorimeter when the temperature of the toner is raised from 30° C. to 170° C. at a rate of 10° C./min, and let Tg2 be the glass transition point of the toner as measured using a differential scanning calorimeter when, after the measurement of Tg1, it is cooled to 30° C. at a rate of 100° C./min and is raised again from 30° C. to 170° C. at a rate of 10° C./min. Then, Tg(45), which is the value of Tg1 after the toner is left to stand still for 100 hours at 45° C., and Tg(25), which is the value of Tg1 after the toner is left to stand still for 100 hours at 25° C., satisfy the relationships given by formulae (1) and (2) below:

$$0 < T g 2 - T g ( 45 ) < 5 \qquad ( 1 )$$

$$4 < Tg 2 - T g ( 25 ) < 10 \qquad ( 2 )$$

Setting Tg2 lower than Tg1 helps maintain low temperature fixing properties, and setting the difference between Tg1 and Tg2 in a predetermined range helps improve the stability of toner in high-temperature environment. This yields magnetic one-component toner that has low temperature fixing properties and excels in high-temperature preservation properties and heat-stress resistance and that is suitable for high linear velocity process that produces a high stress in a development system.

### [3. Material of Toner]

Now, a description will be given, one by one, of the binder resin, the magnetic powder, a colorant, the release agent, the charge control agent that form the toner base particle, the external additives externally added to the toner base particle, and a method for producing the toner according to the present disclosure.

### (Binder Resin)

The toner base particle that forms the toner according to the present disclosure contains a binder resin. The toner base particle contains a polyester resin as a binder resin. Specifically, the toner base particle contains an amorphous polyester resin and a crystalline polyester resin as a binder resin. Using a crystalline polyester resin in the toner base particle can give the toner base particle sharp-melting properties.

Usable as polyester resins are those obtained by condensation polymerization or condensation copolymerization of a dihydric or a trihydric or higher alcohol component and a divalent or a trivalent or higher carboxylic acid component. Examples of components used to synthesize a polyester resin include alcohol components or carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and Empol trimer acid. These divalent or trivalent or higher carboxylic acid components may be used as ester-forming derivatives such as acid halides, acid anhydrides, and lower alkyl esters. Here, the term “lower alkyl” denotes an alkyl group with one to six carbon atoms.

Suitable as the amorphous polyester resin is a polymer of one or more bisphenols (specifically, bisphenol A ethylene oxide adduct, bisphenol A propylene oxide adduct, and the like) and one or more dicarboxylic acids (specifically, terephthalic acid, fumaric acid, alkyl succinic acid, and the like).

Examples of suitable crystalline polyester resins include a polymer of one or more aliphatic dicarboxylic acids with a carbon number of 10 or more but 15 or less (specifically, suberic acid, adipic acid, succinic acid, and the like) and one or more aliphatic diols with a carbon number of 3 or more but 9 or less (specifically, ethylene glycol, propane diol, butane diol, pentane diol, hexane diol, and the like). If an aliphatic diol with a carbon number of 10 or more (e.g., 1,12-dodecandiol) is used, the toner has degraded heat stress resistance as will be described later in connection with comparative example.

Examples of more suitable crystalline polyester resins include a copolymer of one or more aliphatic dicarboxylic acids with a carbon number of 10 or more but 15 or less, one or more aliphatic diols with a carbon number of 3 or more but 9 or less, and one or more of aromatic dicarboxylic acids.

The degree of crystallinity of the crystalline polyester resin can be determined with its degree of crystallinity at the start of annealing taken as 0% and its degree of crystallinity after annealing up to saturation of the degree of crystallinity taken as 100%. The degree of crystallinity of the crystalline polyester resin is a value measured based on the X-ray diffraction intensity of the target peak (a peak attributable to the crystalline polyester resin) in an X-ray diffraction spectrum.

The glass transition point (Tg) of the polyester resin is preferably 40° C. or more but 70° C. or less. Too high a glass transition point can result in poor low temperature fixing properties of the toner. Too low a glass transition point can result in poor heat-resistant preservation properties of the toner.

The glass transition point of the polyester resin can be determined from the changing point of the specific heat of the polyester resin using a differential scanning calorimeter (DSC). More specifically, the glass transition point of the polyester resin can be determined by plotting the endothermic curve of the polyester resin using a differential scanning calorimeter (DSC-6200, manufactured by Seiko Instruments Inc.), as a measuring instrument. 10 mg of a measurement sample is put in an aluminum pan while an empty aluminum pan is used as a reference. From the endothermic curve of the polyester resin plotted through measurement in a normal-temperature normal-humidity environment in the range of measurement temperature from 25° C. or more but 200° C. or less at a heating rate of 10° C./min, the glass transition point of the polyester resin can be determined.

The softening point of the polyester resin is preferably 70° C. or more but 130° C. or less, and more preferably 80° C. or more but 120° C. or less. For improved mechanical strength of the toner base particle and improved fixing properties of the toner, the number average molecular weight (Mn) of the polyester resin is preferably 1000 or more but 2000 or less. The molecular weight distribution of the polyester resin (the ratio Mw/Mn of mass average molecular weight (Mw) to number average molecular weight (Mn)) is preferably 9 or more but 21 or less.

As the binder resin, while an amorphous polyester resin and a crystalline polyester resin are used for their satisfactory fixing properties on sheets, a polyester resin can be used not only singly but also with a cross-linking agent or a thermosetting resin added to it. Adding a cross-linking agent or a thermosetting resin so that the binder resin partly has a cross-linked structure helps improve the heat-resistant preservation properties, durability, and the like of the toner without degrading the fixing properties of the toner.

The toner base particle can contain, in addition to the polyester resins mentioned above, another binder resin. Examples of another binder resin include a thermoplastic resin and a thermosetting resin. Thermoplastic resins that can be used with the polyester resins include styrene-based resins, acrylic-based resins, styrene-acrylic-based resins, polyethylene-based resins, polypropylene-based resins, vinyl chloride-based resins, polyamide resins, polyurethane resins, polyvinyl alcohol-based resins, vinyl ether-based resins, N-vinyl-based resins, and styrene-butadiene resins. Two or more of these thermoplastic resins can be used in combination.

As a thermosetting resins usable with the polyester resins, an epoxy resin or a cyanate-based resin is preferred. Examples of suitable thermosetting resins include bisphenol A-type epoxy resins, hydrogenated bisphenol A-type epoxy resins, novolak-type epoxy resins, polyalkylene ether-type epoxy resins, cyclic aliphatic group-type epoxy resins, and cyanate resins. Two or more of these thermosetting resins can be used in combination.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polystyrene resin.

### (Magnetic Powder)

The toner base particle contains a magnetic powder in the binder resin. Examples of the material of the magnetic powder include: a magnetic iron oxide or a compound of a divalent metal with an iron oxide, such as magnetite, maghemite, and ferrite; a powder of a metal such as iron, cobalt, or nickel or of an alloy of any of these metals with a metal such as aluminum, copper, lead, magnesium, tin, zinc, antimony, beryllium, bismuth, cadmium, calcium, manganese, selenium, titanium, tungsten, or vanadium; or a mixture of any of those powdery substances.

The particle size of the magnetic powder is not limited within the scope consistent with the object of the present disclosure. Specifically, the particle size of the magnetic powder is preferably 0.05 to 2.0 μm, and more preferably 0.1 μm or more but 1.0 μm or less. Using a magnetic powder with a particle size in those ranges makes it easy to disperse the magnetic powder uniformly in the binder resin.

As the magnetic powder, it is possible to use a product surface-treated using a surface treatment agent such as a titanium-based coupling agent or silane-based coupling agent for the purpose of improving the dispersion properties of the magnetic powder in the binder resin.

The amount of magnetic powder used is not particularly limited within the scope consistent with the object of the present disclosure. Specifically, the amount of magnetic powder used is preferably, relative to 100 mass parts of the binder resin, approximately 10 to 150 mass parts, and more preferably 30 mass parts or more but 60 mass parts or less. Using too large an amount of magnetic powder can make it difficult to form images with the desired image density for a long period, or can lead to extremely poor fixing properties of the toner to sheets. Using too small an amount of magnetic powder can cause image fogging, or can make it difficult to form images with the desired image density for a long period.

### (Colorant)

Containing a magnetic powder as an essential component, the toner base particle is generally black. Accordingly, within the scope consistent with the object of the present disclosure, for the purpose of obtaining a more preferred tone of black in the image formed using the toner according to the present disclosure, the toner can contain as a colorant any known dye or pigment. Specifically, one example of a pigment is carbon black and one example of a dye is an acid violet

The amount of colorant used is not particularly limited within the scope consistent with the object of the present disclosure. Specifically, the amount of colorant used is preferably, relative to the total mass of the toner base particle, 1 mass % or more but 10 mass % or less, and more preferably 2 mass % or more but 7 mass % or less.

A colorant can be used as a master batch having a colorant previously dispersed in a resin material such as a thermoplastic resin. When a colorant is used as a master batch, the resin contained in the master batch is preferably a resin of the same type as the binder resin.

### (Release Agent)

For the purpose of improving its fixing properties and offset resistance, the toner base particle can contain a release agent. The type of release agent that can be contained in the toner base particle is not particularly limited. As the release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding these release agents to the toner base particle helps more efficiently suppress offsetting and image smearing (stain around an image caused by its being rubbed).

When a polyester resin is used as the binder resin, from the viewpoint of compatibility, as a release agent, one or more release agents selected from the group consisting of carnauba wax, synthetic ester wax, and polyethylene wax is suitably used. On the other hand, when a polystyrene-based resin is used as the binder resin, likewise from the viewpoint of compatibility, as a release agent, Fischer-Tropsch wax and/or paraffine wax is suitably used.

Fischer-Tropsch wax is a straight-chain hydrocarbon compound with few iso-structure molecules or side-chains that is produced by exploiting the Fischer-Tropsch reaction, which is a catalytic hydrogenation reaction of carbon monoxide.

Preferred among different types of Fischer-Tropsch wax are those that have a mass average molecular weight of 1,000 or more of which the bottom temperature of the endothermic peak observed by DSC measurement falls within the range of 100° C. or more but 120° C. or less. Examples of such types of Fischer-Tropsch wax include the following products available from Sasol Ltd.: Sasol Wax Cl (endothermic peak bottom temperature: 106.5° C.), Sasol Wax C105 (endothermic peak bottom temperature: 102.1° C.), Sasol Wax Spray (endothermic peak bottom temperature: 102.1° C.), and the like.

The amount of release agent used is not particularly limited within the scope consistent with the object of the present disclosure. Specifically, the amount of release agent used is, relative to the total mass of the toner base particle, preferably 1 mass % or more but 10 mass % or less. Using too small an amount of release agent can result in less-than-expected suppression of offsetting or image smearing in image formation; using too large an amount of release agent can result in fusing-together of toner particles and hence poor heat-resistant preservation properties of toner.

### (Charge Control Agent)

The toner base particle can contain a charge control agent for the purpose of improving the charge level of the toner and its charge response properties as an index of whether it can be charged to a predetermined charge level in a short time and thereby obtaining toner with excellent durability and stability. Since the toner according to the present disclosure is positively chargeable toner, a positively chargeable charge control agent is used.

The type of charge control agent that can be contained in the toner base particle is not particularly limited within the scope consistent with the object of the present disclosure. Any of charge control agents known to be used in toner can be appropriately selected and used. Specific examples of positively chargeable charge control agents include: direct dyes composed of azine compounds such as pyridazine, pyrimidine, pyrazine, orthoxazine, metaoxazine, paraoxazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; nigrosine compounds, such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; triphenylmethane-based dyes; alkoxylated amines; alkylamides; and quaternary ammonium salts, such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins is not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferred. Specific examples of preferred acrylic-based comonomers for copolymerization with the styrene unit in styrene-acrylic-based resin having as a functional group a quaternary ammonium salt include esters of alkyl (meth)acrylates such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acrylamide include dimethyl methacryl amide. Specific examples of dialkyl aminoalkyl (meth)acrylamide include dimethyl aminopropyl methacrylamide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The toner base particle can be a toner base particle with no shell layer (non-capsule toner base particle) or a toner base particle with a shell layer (capsule toner base particle). A capsule toner base particle can be produced by forming a shell layer on the surface of a non-capsule toner base particle (toner core particle). The shell layer can be formed substantially solely of a thermosetting resin, can be formed substantially solely of a thermoplastic resin, or can contain both a thermoplastic resin and a thermosetting resin.

### (External Additive)

In the toner according to the present disclosure, the toner base particle can have its surface treated with an external additive. The type of external additive externally added to the toner according to the present disclosure is not particularly limited within the scope consistent with the object of the present disclosure and thus can be selected appropriately from external additives known to be used in toner. Specific examples of suitable external additives include silica and metal oxides such as alumina, titanium oxide, magnesium oxide, zinc oxide, strontium titanate, and barium titanate. Two or more of these external additives can be used in combination.

The particle size of the external additive is not particularly limited within the scope consistent of the object of the present disclosure. Typically, it is preferably 0.01 μm or more but 1.0 μm or less.

The amount of external additive used is not particularly limited within the scope consistent with the object of the present disclosure. It is preferably, for the total mass of the toner base particle, 0.1 mass % or more but 10 mass % or less, and more preferably 0.2 mass % or more but 5 mass % or less. Using too small an amount of external additive tends to degrade the hydrophobicity of the toner. This makes the toner susceptible to water molecules in the air in a high-temperature high-humidity environment and tends to cause problems such as a drop in the image density of the formed image resulting from an extreme drop in the charge amount of toner as well as a drop in the fluidity of the toner. On the other hand, using too large an amount of external additive may result in a drop in the image density due to the excessive charging of the toner.

### [4. Production Method for Toner]

Next, a production method for the toner according to the present disclosure will be described. The production method for the toner includes a production method for a toner base particle and an external additive treatment method for attaching an external additive to the surface of the toner base particle. The production method for the toner base particle is not particularly limited so long as it forms the toner base particle with a predetermined structure. A toner base particle coated with a shell layer can be used as needed. As a production method suitable for the positively chargeable toner described above, a production method for the toner base particle and an external additive treatment method will be described one by one.

### (Production Method for Toner Base Particle)

The method for producing the toner base particle is not particularly limited so long as it can satisfactorily disperse a magnetic powder and any components such as a colorant, a release agent, and a charge control agent in the binder resin. Examples of suitable production methods for the toner base particle include a pulverization method and an agglomeration method.

In a pulverization method, the binder resin is mixed with the components such as the magnetic powder, colorant, release agent, and charge control agent using a mixer or the like; then the binder resin and the components blended in it are melted and kneaded using a kneader such as a uniaxial or biaxial extruder; and then the cooled kneaded product is pulverized and classified. The average particle size of the toner base particle is not particularly limited within the scope consistent with the object of the present disclosure; typically, it is preferably 5 μm or more but 10 μm or less.

In an agglomeration method, in an aqueous solvent containing fine particles of each of the binder resin, magnetic powder, colorant, release agent, charge control agent, and the like, those fine particles are agglomerated until they form particles of the desired particle size. This produces agglomerated particles containing the binder resin, release agent, charge control agent, and colorant. Subsequently, the obtained agglomerated particles are heated so that the components of the agglomerated particles coalesce. In this way, a toner base particle with the desired particle size is obtained.

### (External Additive Treatment Method)

The method for treating the toner base particle with the external additive is not particularly limited; the toner base particle can be treated by any known method. Specifically, the toner base particle is treated with the external additive using a mixer such as a Turbula mixer, a Henschel mixer, a Nauta mixer, or a V-shape mixer under treatment conditions adjusted so that the particles of the external additive do not sink into the toner base particle.

With the toner according to the present disclosure described above, which excels in fixing properties and heat-resistant preservation properties, when images are formed for a long period in various environments such as a high-temperature high-humidity environment and a low-temperature low-humidity environment, it is possible to charge the toner with the desired charge amount and to form images with the desired density. Thus, the toner according to the present disclosure for development of electrostatic latent images can be used suitably in various image forming apparatuses. In particular, it is preferable to use the toner according to the present disclosure in an image forming apparatus 100 like the one shown in FIG. 1 of which the process linear velocity is 250 mm/sec or more because it can suppress the degradation of heat-stress resistance and fixing properties. Now, the effects of the present disclosure will be described more specifically by way of examples. The present disclosure is not limited in any way by those examples.

### Examples

### Production Example 1

### (Production of Crystalline Polyester Resin C-1)

A four-neck flask with a volume of 2 L equipped with a thermometer, a nitrogen introduction pipe made of glass, a stirrer (with a stirring blade made of stainless steel), and a downflow condenser (heat exchanger) was loaded with 50 mol parts of 1,9-nonanediol, 45 mol parts of 1,10-decanedicarboxylic acid, 5 mol parts of terephthalic acid, and 0.05 mol parts of a catalyst (tetra-n-butoxy titanium). Then, the flask was put on a mantle heater and nitrogen gas was introduced into the flask through the nitrogen introduction pipe to produce a nitrogen atmosphere (inert atmosphere) in the flask. Subsequently, in the nitrogen atmosphere, while the contents of the flask were stirred, their temperature was raised to 200° C., and then, in the nitrogen atmosphere and under the condition of 200° C., while the contents of the flask were stirred, they were reacted (condensation-polymerized). After that, the contents of the flask were taken out into a container (vat) made of stainless steel and were cooled to a temperature of 25° C. in a room-temperature environment to obtain crystalline polyester resin C-1.

### (Production of Crystalline Polyester Resin C-2)

Crystalline polyester resin C-2 was obtained through a procedure similar to that for crystalline polyester resin C-1 except that, instead of 50 mol parts of 1,9-nonanediol, 50 mol parts of 1,12-dodecanediol was used and that the reaction temperature was changed from 200° C. to 220° C.

### Production Example 2

### (Production of Amorphous Polyester Resin A-1)

A four-neck flask with a volume of 2 L equipped with a thermometer, a nitrogen introduction pipe made of glass, a stirrer (with a stirring blade made of stainless steel), and a downflow condenser (heat exchanger) was loaded with 43 mol parts of ethylene glycol, 42 mol parts of terephthalic acid, and 5 mol parts of 1,2,4-benzenetricarboxylic acid anhydride. Then, the flask was put on a mantle heater and nitrogen gas was introduced into the flask through the nitrogen introduction pipe to produce a nitrogen atmosphere (inert atmosphere) in the flask. Subsequently, in the nitrogen atmosphere, while the contents of the flask were stirred, their temperature was raised up to 230° C., and then, in the nitrogen atmosphere and under the condition of 230° C., while the contents in the flask were stirred, they were reacted (condensation-polymerized) for 6 hours. After that, the contents of the flask were taken out into a container (vat) made of stainless steel and were cooled to a temperature of 25° C. in a room-temperature environment to obtain amorphous polyester resin A-1.

### (Production of Amorphous Polyester Resin A-2)

Amorphous polyester resin A-2 was obtained through a procedure similar to that for amorphous polyester resin A-1 except that the mixture was reacted in the nitrogen atmosphere and under the condition of 230° C. for 8 hours.

### (Production of Amorphous Polyester Resin A-3)

Amorphous polyester resin A-3 was obtained through a procedure similar to that for amorphous polyester resin A-1 except that the mixture was reacted in the nitrogen atmosphere and under the condition of 230° C. for 4 hours.

### Production Example 3

### (Production of Magnetic Powder)

30 L of an aqueous solution of ferrous sulfate containing Fe²⁺ at a concentration of 2.0 mol/L and 28 L of 4.5N (normality) an aqueous solution of sodium hydroxide were loaded and mixed in a reaction vessel. Subsequently, the temperature of the contents of the vessel was raised to 90° C. and the pH value of the contents of the vessel was adjusted to 10.5 using an aqueous solution of sodium hydroxide. Then, under the conditions of a pH value of 10.5 and a temperature of 90° C., air was blown into the vessel at a rate of 80 L/min for 100 minutes to promote the oxidation of the ferrous in the vessel. An aqueous solution of sulfuric acid was then added into the vessel to adjust the pH value of the contents of the vessel to 7. The temperature of the contents of the vessel was kept at 90° C. and air was blown into the vessel at a rate of 80 L/min for 10 minutes. This produced magnetite particles in the liquid and a suspension containing magnetite particles was obtained. Then, from the obtained suspension, magnetite particles (powdery substance) were filtered off. Subsequently, the obtained magnetite particles (powdery substance) were washed with water and dried to obtain an agglomeration product of magnetite particles. The obtained agglomeration product was then pulverized to obtain a magnetic powder containing a large number of octahedral magnetite particles. Of the obtained magnetic powder, the number average primary particle size was 0.2 μm; the coercivity in an external magnetic field of 796 kA/m was 8.5 kA/m; the saturation magnetization was 82 Am²/kg; and the remanent magnetization was 5.0 Am²/kg.

### Production Example 4

### (Production of Toner T-1)

### (Production of Toner Base Particle)

50 mass parts of amorphous polyester resin A-1 obtained in production example 2, 2 mass parts of crystalline polyester resin C-1 obtained in production example 1, 42 mass parts of magnetic powder obtained in production example 3, 1 mass part of a first charge control agent (BONTRON N-77, manufactured by ORIENT CHEMICAL INDUSTRIES CO., LTD., component: an azine compound), 3 mass parts of a second charge control agent (Acrybase FCA-207P, manufactured by Fujikura Kasei Co., Ltd., component: styrene-acrylic-based resin containing a repeating unit derived from a quaternary ammonium salt), 2 mass parts of ester wax (Nissan Electol WEP-3, manufactured by NOF CORPORATION) as a release agent were mixed for 4 minutes at a rotation rate of 2000 rpm using an FM mixer (FM-20, manufactured by NIPPON COKE & ENGINEERING CO., LTD.). Then, the obtained mixture was melted and kneaded using a biaxial extruder (PCM-30, manufactured by Ikegai Co., Ltd.) under the conditions of a melting-kneading temperature (cylinder temperature) of 120° C., a rotation rate 150 rpm, and a processing rate of 100g/min.

The obtained kneaded product was cooled and was then coarsely pulverized using a pulverizer (Roteplex, manufactured by Hosokawa Micron Corporation) at a set particle size of 2 mm. The obtained coarsely pulverized product was finely pulverized using a mechanical pulverizer (Turbomill T250, manufactured by Freund-Turbo Corporation). The obtained finely pulverized product was classified using a wind-power classifier (Elbow-Jet EJ-LABO model, manufactured by NITTETSU MINING). This yielded toner base particles with a volume median size (D50) of 8 μm.

### (External Addition Process)

To 100 mass parts of the obtained toner base particles, as external additives, 0.8 mass parts of positively chargeable silica particles (AEROSIL RA 200, manufactured by Nippon AEROSIL CO., LTD.; dry silica particles surface treated to be hydrophobic and positively chargeable, surface treatment agents; hexamethyldisilazane (HMDS) and aminosilane, number average primary particle size: approximately 12 nm) and 0.8 mass parts of conductive titanium oxide particles (EC-100, manufactured by Titan Kogyo, Ltd.; base material: TiO₂, coating layer: Sb-doped SnO₂ film, number average primary particle size: approximately 0.35 μm) were added and mixed for five minutes at a rotation rate of 2000 rpm using an FM mixer (FM-20, manufactured by NIPPON COKE & ENGINEERING CO., LTD.) to attach (externally add) the external additives (positively chargeable silica particles and conductive titanium oxide particles) to the toner base particles. After that, the mixture was sieved using a 300-mesh sieve (with 48 μm openings) to obtain toner T-1.

### (Production of Toner T-2)

Toner T-2 was obtained through a procedure similar to that for toner T-1 except that the melting-kneading temperature was changed to 110° C.

### (Production of Toner T-3)

Toner T-3 was obtained through a procedure similar to that for toner T-1 except that the melting-kneading temperature was changed to 140° C.

### (Production of Toner T-4)

Toner T-4 was obtained through a procedure similar to that for toner T-1 except that amorphous polyester resin A-1 was changed to amorphous polyester resin A-2.

### (Production of Toner T-5)

Toner T-5 was obtained through a procedure similar to that for toner T-1 except that amorphous polyester resin A-1 was changed to amorphous polyester resin A-3.

### (Production of Toner T-6)

Toner T-6 was obtained through a procedure similar to that for toner T-1 except that the added amount of crystalline polyester resin C-1 was changed to 2.4 mass parts.

### (Production of Toner T-7)

Toner T-7 was obtained through a procedure similar to that for toner T-1 except that the added amount of crystalline polyester resin C-1 was changed to 1.2 mass parts.

### (Production of Toner T-8)

Toner T-8 was obtained through a procedure similar to that for toner T-1 except that the added amount of crystalline polyester resin C-1 was changed to 0.1 mass parts.

### (Production of Toner T-9)

Toner T-9 was obtained through a procedure similar to that for toner T-1 except that amorphous polyester resin A-1 was changed to amorphous polyester resin A-2 and the melting-kneading temperature was changed to 140° C.

### (Production of Toner T-10)

Toner T-10 was obtained through a procedure similar to that for toner T-1 except that amorphous polyester resin A-1 was changed to amorphous polyester resin A-3 and the melting-kneading temperature was changed to 140° C.

### (Production of Toner T-11)

Toner T-11 was obtained through a procedure similar to that for toner T-1 except that amorphous polyester resin A-1 was changed to amorphous polyester resin A-2 and the melting-kneading temperature was changed to 110° C.

### (Production of Toner T-12)

Toner T-12 was obtained through a procedure similar to that for toner T-1 except that amorphous polyester resin A-1 was changed to amorphous polyester resin A-3 and the melting-kneading temperature was changed to 110° C.

### (Production of Toner T-13)

Toner T-13 was obtained through a procedure similar to that for toner T-1 except that the added amount of crystalline polyester resin C-1 was changed to 1.2 mass parts and the melting-kneading temperature was changed to 140° C.

### (Production of Toner T-14)

Toner T-14 was obtained through a procedure similar to that for toner T-1 except that crystalline polyester resin C-1 was changed to crystalline polyester resin C-2.

Table 1 shows, for toners T-1 to T-14, the melting-kneading temperature, the types of amorphous polyester resin and crystalline polyester resin, and the ratio (mass %) of crystalline polyester resin to amorphous polyester resin.

TABLE 1

| | | Amorphous | Crystalline | Crystalline/ |
|---|---|---|---|---|
| | Melting-Kneading | Polyester | Polyester | Amorphous |
| Toner | Temperature [° C.] | Resin | Resin | [mass %] |
| T-1 | 120 | A-1 | C-1 | 4.0 |
| T-2 | 110 | A-1 | C-1 | 4.0 |
| T-3 | 140 | A-1 | C-1 | 4.0 |
| T-4 | 120 | A-2 | C-1 | 4.0 |
| T-5 | 120 | A-3 | C-1 | 4.0 |
| T-6 | 120 | A-1 | C-1 | 4.8 |
| T-7 | 120 | A-1 | C-1 | 2.4 |
| T-8 | 120 | A-1 | C-1 | 0.2 |
| T-9 | 140 | A-2 | C-1 | 4.0 |
| T-10 | 140 | A-3 | C-1 | 4.0 |
| T-11 | 110 | A-2 | C-1 | 4.0 |
| T-12 | 110 | A-3 | C-1 | 4.0 |
| T-13 | 140 | A-1 | C-1 | 2.4 |
| T-14 | 120 | A-1 | C-2 | 4.0 |

### (Measurement of Toner's Glass Transition Points Tg(25), Tg(45), and Tg2)

Approximately 1 g of toner in an open plastic container of a volume 20 cc was exposed in a thermostatic chamber of 45° C. for 100 hours. The toner taken out was taken as a sample left to stand still at 45° C. Likewise, toner that was exposed in a thermostatic chamber of 25° C. for 100 hours was taken as a sample left to stand still at 25° C.

As a differential scanning calorimeter (DSC), DSC7020 (manufactured by Seiko Instruments Inc.) was used. Approximately 10 mg of the sample left to stand still at 45° C. was put in an aluminum dish and was placed in a measurement portion of the DSC. The measurement temperature at the start was set to 30° C. and was raised to 170° C. at a rising rate of 10° C./min to measure Tg(45). After the measurement of Tg(45), the sample was cooled to 30° C. at a rate of 100° C./min. Then, the temperature of the sample was raised from 30° C. to 170° C. at a rising rate of 10° C./min to measure Tg2. Likewise, with the sample left to stand still at 25° C., Tg(25) and Tg2 were measured.

### [Evaluation of Heat Stress Resistance and Fixing Properties of Toner]

For each of toners T-1 to T-14, heat stress resistance and fixing properties were evaluated by the methods described below.

### (Heat Stress Resistance)

Used as an evaluation machine was a test machine prepared by modifying a monochrome printer (ECOSYS MA6000, manufactured by Kyocera Document Solutions Inc.) such that the application voltage of a development system was variable. Toners T-1 to T-14 obtained in production example 4 were each installed in a developing portion of the evaluation machine. Toner for supply (the same toner as the toner installed in the developing portion) was also installed in a toner container of the evaluation machine. After the installation of the toner, in a high-temperature high-humidity environment (32° C., 80% RH), an image at a coverage rate of 5% was printed on 2000 sheets, and then a halftone image at a coverage rate of 25% was printed to obtain a measurement image. With this image, the heat stress resistance of the toner was checked. If the toner has poor heat stress resistance, a white streak appears in the image due to the agglomeration of toner. The evaluation criteria for heat stress resistance were as follows:
GOOD: No vertical white streak appeared.
POOR: One or more vertical white streaks appeared.

### (Fixing Properties)

In a normal-temperature normal-humidity environment (20° C., 50% RH), the evaluation machine with the power off was cooled for 10 minutes, and it was then turned on. Then a fixing pattern solid image (the amount of toner 1.5 mg/cm²) was printed on 5 sheets continuously to obtain a measurement image. The measurement image was rubbed, with a weight (1 kg) wrapped in cloth, back and forth ten times. The image density before and after this operation was measured using a Macbeth reflection densimeter (RD914, manufactured by GretagMacbeth Ltd.) to determine the ratio of the image density before the operation to that after the operation, and this ratio was taken as fixing rate. The evaluation criteria for fixing properties were as follows:
GOOD: The fixing rate was 95% or more.
OK: The fixing rate was 90% or more but less than 95%.
POOR: The fixing rate was less than 90%.

Table 2 shows the results of evaluation of heat stress resistance and fixing properties of toners T-1 to T-8 (Practical Examples 1 to 8) and toners T-9 to T-14 (Comparative Examples 1 to 6) as well as the values of Tg(45), Tg(25), Tg2, Tg2−Tg(45), and Tg2−Tg(25).

TABLE 2

| | | | | | Tg2 − | Tg2 − | Heat-Stress | Fixing Properties | |
|---|---|---|---|---|---|---|---|---|---|
| | | Tg(45) | Tg(25) | Tg2 | Tg(45) | Tg(25) | Resistance | Fixing | |
| | Toner | [° C.] | [° C.] | [° C.] | [° C.] | [° C.] | (White Streak) | Rate [%] | Judgment |
| Practical Example 1 | T-1 | 59.7 | 55.2 | 62.3 | 2.6 | 7.1 | GOOD | 98 | GOOD |
| Practical Example 2 | T-2 | 57.5 | 52.8 | 62.3 | 4.8 | 9.5 | GOOD | 98 | GOOD |
| Practical Example 3 | T-3 | 62.0 | 58.0 | 62.3 | 0.3 | 4.3 | GOOD | 97 | GOOD |
| Practical Example 4 | T-4 | 54.5 | 54.2 | 59.2 | 4.7 | 5.0 | GOOD | 100 | GOOD |
| Practical Example 5 | T-5 | 65.7 | 56.4 | 66.0 | 0.3 | 9.6 | GOOD | 96 | GOOD |
| Practical Example 6 | T-6 | 59.6 | 52.7 | 62.3 | 2.7 | 9.6 | GOOD | 99 | GOOD |
| Practical Example 7 | T-7 | 59.9 | 56.5 | 62.3 | 2.4 | 5.8 | GOOD | 98 | GOOD |
| Practical Example 8 | T-8 | 60.0 | 57.9 | 62.3 | 2.3 | 4.4 | GOOD | 97 | GOOD |
| Comparative Example 1 | T-9 | 56.4 | 55.7 | 59.2 | 2.8 | 3.5 | POOR | 100 | GOOD |
| Comparative Example 2 | T-10 | 66.1 | 58.5 | 66.0 | −0.1 | 7.5 | GOOD | 80 | POOR |
| Comparative Example 3 | T-11 | 63.7 | 55.4 | 66.0 | 2.3 | 10.6 | GOOD | 85 | POOR |
| Comparative Example 4 | T-12 | 53.8 | 51.8 | 59.2 | 5.4 | 7.4 | POOR | 100 | GOOD |
| Comparative Example 5 | T-13 | 62.5 | 58.8 | 62.3 | −0.2 | 3.5 | GOOD | 88 | POOR |
| Comparative Example 6 | T-14 | 60.1 | 55.9 | 62.4 | 2.3 | 6.5 | POOR | 98 | GOOD |

Table 2 reveals the following. Toners T-1 to T-8 of Practical Examples 1 to 8, in which 0<Tg2−Tg(45)<5 and 4<Tg2−Tg(25)<10 held, were all good in heat stress resistance and fixing properties.

In contrast, toner T-9 of Comparative Example 1, in which Tg2−Tg(25) was 3.5, that is, less than the lower threshold value, and toner T-12 of Comparative Example 4, in which Tg2-Tg(45) was 5.4, that is, more than the upper threshold value, were poor in heat stress resistance. On the other hand, toner T-11 of Comparative Example 3, in which Tg2−Tg(25) was 10.6, that is, more than the upper threshold value, toner T-10 of Comparative Example 2, in which Tg2-Tg(45) was −0.1, that is, less than the lower threshold value, and toner T-13 of Comparative Example 5, in which Tg2−Tg(45) was −0.2, were poor in fixing properties.

In addition, toner T-14 of Comparative Example 6, in which crystalline polyester resin C-2 was used as a binder resin in the toner base particle instead of crystalline polyester resin C-1, was poor in heat stress resistance.

The above results confirm that using an aliphatic diol with a carbon number of 3 to 9 as a material of a crystalline polyester resin that forms a toner base particle and setting the glass transition points Tg(45), Tg(25), and Tg2 to satisfy the relationships 0<Tg2−Tg(45)<5 and 4<Tg2−Tg(25)<10 yields magnetic one-component toner that excels in heat stress resistance and fixing properties.

The present disclosure finds application in positively chargeable magnetic one-component toner for use in electrophotography. Based on the present disclosure, it is possible to provide magnetic one-component toner that has low temperature fixing properties and that excels in heat-resistant preservation properties and heat stress resistance.

What is claimed is:

1. Magnetic one-component toner comprising a toner particle having:
a toner base particle containing at least a binder resin and a magnetic powder; and
an external additive attached to a surface of the toner base particle,
wherein
the binder resin contains an amorphous polyester resin and a crystalline polyester resin, and an amount of the crystalline polyester resin added is 5 mass % or less relative to the amorphous polyester resin,
the crystalline polyester resin includes one or more aliphatic diols with a carbon number of 3 or more but 9 or less, and
let Tg1 be a glass transition point measured using a differential scanning calorimeter when temperature is raised for the first time and let Tg2 be a glass transition point measured when, after a measurement of Tg1, temperature is lowered and raised again, then
Tg(45), which is a value of Tg1 measured after standing still at 45° C. for 100 hours and Tg(25), which is a value of Tg1 measured after standing still at 25° C. for 100 hours satisfy formulae (1) and (2) below:
$$0 < T g 2 - T g ( 45 ) < 5 \qquad ( 1 )$$
$$4 < Tg 2 - T g ( 25 ) < 10 \qquad ( 2 )$$

2. The magnetic one-component toner according to claim 1, wherein
the crystalline polyester resin is a copolymer of the aliphatic diol, one or more aliphatic dicarboxylic acids with a carbon number of 10 or more but 15 or less, and one or more aromatic dicarboxylic acids.

3. An image forming apparatus comprising:
a developing device that develops using the magnetic one-component toner according to claim 1 an electrostatic latent image formed on an image carrying member into a toner image,
wherein
a linear velocity of the image carrying member is 250 mm/sec or more.
